(19) United States
(12) Patent Application Publication
(10) Pub. No.: US 2024/0223546 A1
(43) Pub. Date: Jul. 4, 2024

(54) SECURE INFORMATION RETRIEVAL

(71) Applicant: Advisor First, LLC, Overland Park, KS (US)

(72) Inventor: Ron SLOOP, Overland Park, KS (US)

(21) Appl. No.: 18/541,752

(22) Filed: Dec. 15, 2023

Related U.S. Application Data
(60) Provisional application No. 63/436,179, filed on Dec. 30, 2022.

(51) Int. Cl. H04L 9/40

(52) U.S. Cl. CPC H04L 63/08

(57) ABSTRACT

The secure aggregation device will login to an institution's website, search for the relevant information for an agent's policies, extract that information, and export it to the agent's client site. The secure aggregation device described herein will do this work on a continual basis to keep all of the agent's data up to date.

### CROSS-REFERENCE TO RELATED APPLICATION

This application claims the benefit of U.S. Provisional Application No. 63/436,179, filed Dec. 30, 2022, the entirety of which is hereby incorporated by reference.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Financial advisors have unique information security concerns. Financial advisors sell and maintain products from multiple institutions to their clients. For example, a client may buy and sell financial instruments through a first institution, buy insurance through a second, and bank at a third institution. While serving their clients, advisors must pull information from those institutions and combine that information into a consolidated view of their client's financial situation. Each institution has different logins, naming conventions, presentations of data, and other variances that makes the consolidation of the information very difficult and time-consuming. Agents generally have no recourse but to login to websites to manually perform the work. There is not currently a good method for securely logging into multiple institutions while maintaining secure control over credentials and authentication information.

The secure aggregation device resolves this problem by securely automating this manual work. The secure aggregation device will login to an institutions website, search for the relevant information for an agent's policies, extract that information, and export it to the agent's client site. The secure aggregation device described herein will do this work on a continual basis to keep all of the agent's data up to date.

### BRIEF DESCRIPTION OF THE DRAWINGS

The present invention is described in detail below with reference to the attached drawing figures, wherein:

FIG. 1 is a block diagram illustrates an example operating environment suitable for implementing some embodiments of the disclosure;

FIG. 2 is a block diagram depicting an example computing architecture suitable for implementing some embodiments of the disclosure;

FIG. 3 is a flow chart showing a method of secure information retrieval, according to some embodiments;

FIG. 4 is an example screenshot of a user interface for selecting institutions for information retrieval, according to some embodiments;

FIG. 5 is an example screenshot of a user interface for providing user credentials for selected institutions, according to some embodiments;

FIG. 6 is an example screenshot of an institution login page, according to some embodiments;

FIG. 7 is an example screenshot of customer relationship management (CRM) login confirmation page, according to some embodiments;

FIG. 8 is an example screenshot of an institution home page, according to some embodiments;

FIG. 9 is an example user account page, according to some embodiments;

FIG. 10 is an example user account details page, according to some embodiments;

FIG. 11 is an example user account details page, according to some embodiments;

FIG. 12 is an example aggregate data view, according to some embodiments;

FIG. 13 is a block diagram of an example computing device suitable for use in implementing some embodiments described herein;

FIG. 14 is a flow chart illustrating a method of maintaining secure access to website content, according to some embodiments; and

FIG. 15 is a flow chart illustrating a method of maintaining secure access to website content, according to some embodiments.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a stand-alone application, a service or hosted service (stand-alone or in combination with another hosted service), or a plug-in to another product.

Financial advisors have unique information security concerns. Financial advisors sell and maintain products from multiple institutions to their clients. For example, a client may buy and sell financial instruments through a first institution, buy insurance through a second, and bank at a third institution. While serving their clients, advisors must pull information from those institutions and combine that information into a consolidated view of their client's financial situation. Each institution has different logins, naming conventions, presentations of data, and other variances that makes the consolidation of the information very difficult and time-consuming. Agents generally have no recourse but to login to websites to manually perform the work. There is not currently a good method for securely logging into multiple institutions while maintaining secure control over credentials and authentication information.

The secure aggregation device resolves this problem by securely automating this manual work. The secure aggregation device will login to an institution's website, search for the relevant information for an agent's policies, extract that information, and export it to the agent's client site. The secure aggregation device described herein will do this work on a continual basis to keep all of the agent's data up to date.

The secure aggregation device includes several security features that reduce the chance the device could be used to access customer data. Stealing a device will not compromise any customer information. Customer data is retained only as long as necessary to process and pass back to an aggregation service. The customer data and credential data is stored in Random Access memory (RAM) that will not survive the loss of power to the secure aggregation device. Files are stored to disk only as long as necessary to upload, but they are immediately purged.

In aspects, user credentials are never stored on the device long term and authenticated sessions are never persisted beyond a threshold time, such as a day. Unplugging the secure aggregation device results in the loss of every authenticated session with every institution.

All interactions are controlled by the application hub's application program interface (API), which allows the secure aggregation device to be disabled remotely. Interactions with the institution website are still protected through the agent's authentication processes, so attempts to spoof the API would not have access to the agent's authentication methods. The authentication hub may not directly access the institution websites. Instead, the application hub relies on the secure aggregation device to access and collect data that is then transferred to the application hub.

The secure aggregation device supports multi-factor authentication (and encourages it), including both short message service (SMS), email, and hardware security keys. Housing the secure aggregation device in an agent's office gives the agent physical control of operations tied to the device. The shared secret for a device cannot be guessed. The shared secret for a device may utilize a boot time temporary code to secure the device against the remote server and an agent's online account.

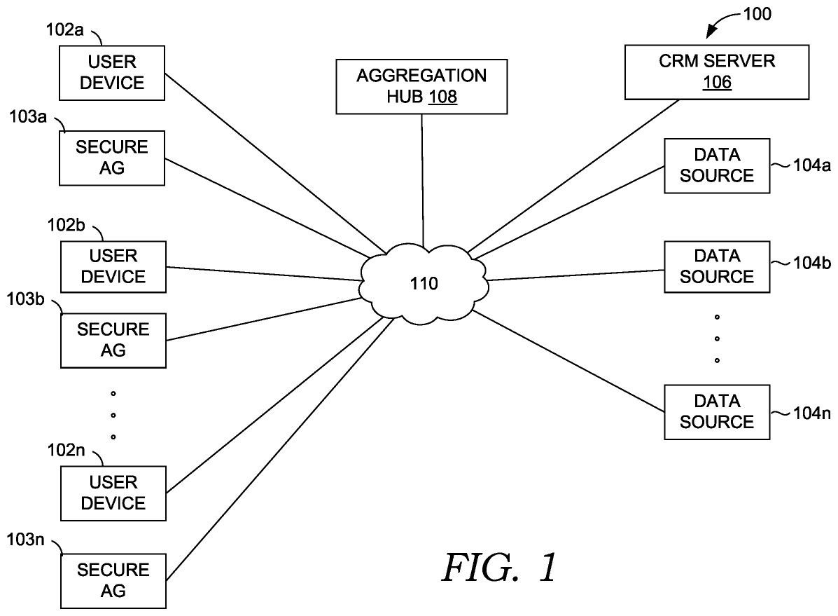

Turning now to FIG. 1, a block diagram is provided showing an example operating environment 100 in which some embodiments of the present disclosure may be employed. It should be understood that this and other arrangements described herein are set forth only as examples. Other arrangements and elements (for example, machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by an entity may be carried out by hardware, firmware, and/or software. For instance, some functions may be carried out by a processor executing instructions stored in memory.

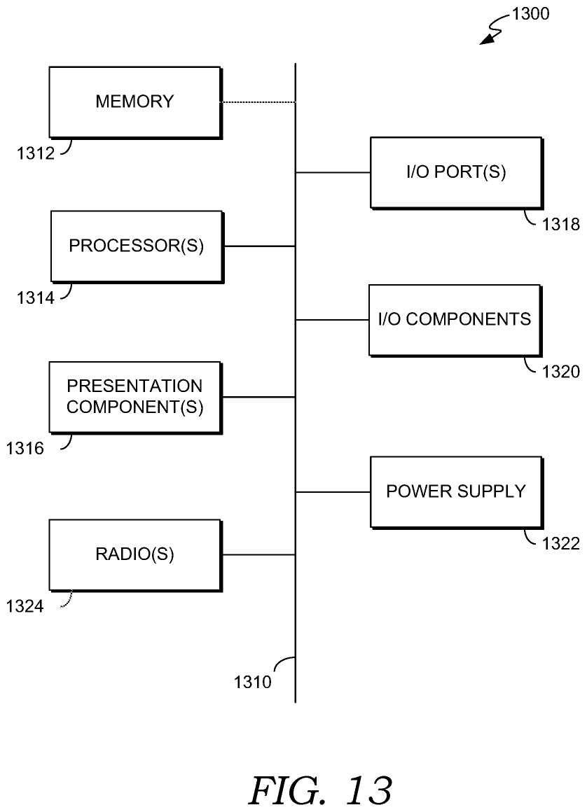

Among other components not shown, example operating environment 100 includes a number of user devices, such as user devices 102a and 102b through 102n; a number of secure aggregation devices, such as secure aggregation devices 103a and 103b through 103n a number of data sources (for example, databases or other data stores), such as data sources 104a and 104b through 104n; customer relationship management (CRM) server 106; aggregation hub 108, and network(s) 110. It should be understood that environment 100 shown in FIG. 1 is an example of one suitable operating environment. Each of the components shown in FIG. 1 may be implemented via any type of computing device, such as computing device 1300 as described in connection to FIG. 13, for example. These components may communicate with each other via network(s) 110, which may include, without limitation, a local area network (LAN) and/or a wide area networks (WAN). In some implementations, network(s) 110 comprises the Internet and/or a cellular network, amongst any of a variety of possible public and/or private networks. As an example, user devices 102a and 102b through 102n and secure aggregation devices 103a and 103b through 103n may interact with the CRM server 106 using network(s) 110. As another example, secure aggregation devices 103a and 103b through 103n may interact with data sources 104a and 104b through 104n and the aggregation hub 108 using network(s) 110.

It should be understood that any number of user devices, servers, and data sources might be employed within operating environment 100 within the scope of the present disclosure. Each may comprise a single device or multiple devices cooperating in a distributed environment. For instance, CRM server 106 and/or aggregation hub 108 may be provided via multiple devices arranged in a distributed environment that collectively provide the functionality described herein. Additionally, other components not shown may also be included within the distributed environment.

User devices 102a and 102b through 102n can be client devices on the client-side of operating environment 100, while CRM server 106 and aggregation hub 108 can be on the server-side of operating environment 100. CRM server 106 and/or aggregation hub 108 can comprise server-side software designed to work in conjunction with client-side software on user devices 102a and 102b through 102n and secure aggregation devices 103a and 103b through 103n to implement any combination of the features and functionalities discussed in the present disclosure. The CRM server 106 provides processes through which a business, such as a financial advisor, administers its interactions with customers. The CRM server 106 may be used by an advisor when speaking with a client. The aggregation hub 108 works with the CRM server 106 by accessing, normalizing, and providing customer data. In aspects, the aggregation hub 108 could be a component of the CRM server 106. In other aspects, the aggregation hub 108 is separate and may provide services to one or more CRM servers 106.

The user devices 102a and 102b through 102n may run a browser or other user interface (UI) that requests institution credentials and presents retrieved institutional data to the aggregation hub 108. The secure aggregation devices 103a and 103b through 103n may receive and store the credentials, login to institution data sources, and retrieve relevant customer data. In some embodiments, the one or more CRM servers 106 and/or aggregation hub 108 represent one or more nodes in a cloud computing environment. Consistent with various embodiments, a cloud computing environment includes a network-based, distributed data processing system that provides one or more cloud computing services. Further, a cloud-computing environment can include many computers, hundreds or thousands of them or more, disposed within one or more data centers and configured to share resources over the one or more network(s) 110.

In some embodiments, a CRM server 106 alternatively or additionally comprises one or more web servers and/or application servers to facilitate delivering web or online content to browsers installed on a user device 102b. Often the content may include static content and dynamic content, such as customer data provided by the aggregation hub 108. When a client application, such as a web browser, requests a website or web application via a URL or search term, the browser typically contacts a web server to request static content or the basic components of a website or web application (for example, HTML pages, image files, video files, and the like). Application servers typically deliver any dynamic portions of web applications or business logic portions of web applications. Business logic can be described as functionality that manages communication between a user device and a data store (for example, a database or knowledge graph). Such functionality can include business rules or workflows (for example, code that indicates conditional if/then statements, while statements, and the like to denote an order of processes).

User devices 102a and 102b through 102n may comprise any type of computing device capable of use by a user. For example, in one embodiment, user devices 102a through 102n may be the type of computing device described in relation to FIG. 13 herein. By way of example and not limitation, a user device may be embodied as a personal computer (PC), a laptop computer, a mobile phone or mobile device, a smartphone, a tablet computer, a smart watch, a wearable computer, a personal digital assistant (PDA), a video player, a handheld communications device, a gaming device or system, an entertainment system, an appliance, a consumer electronic device, a workstation, or any combination of these delineated devices, or any other suitable computer device.

Secure aggregation devices 103a and 103b through 103n may comprise any type of computing device capable of use by a user. For example, in one embodiment, user devices 103a through 103n may be the type of computing device described in relation to FIG. 13 herein. Secure aggregation devices 103a and 103b through 103n may be a small self-contained computer that an agent/advisor will keep in his or her office. It contains the secure aggregation software and a unique key that ties the secure aggregation device to the agent's CRM account. All operations are controlled through commands received from the CRM application program interface (API). When powered-on, the aggregation devices will continually call the CRM API to communicate its status and ask for work to perform. In aspects, a secure aggregation device may have a port (e.g., USB-C) for powering the device, an Ethernet port for internet access, and a USB port to support security keys, which may be part of multi-factor authentication. In aspects, a single agent may use a single secure aggregation device and a single user device to access client data provided by the CRM server 106 and/or aggregation hub 108.

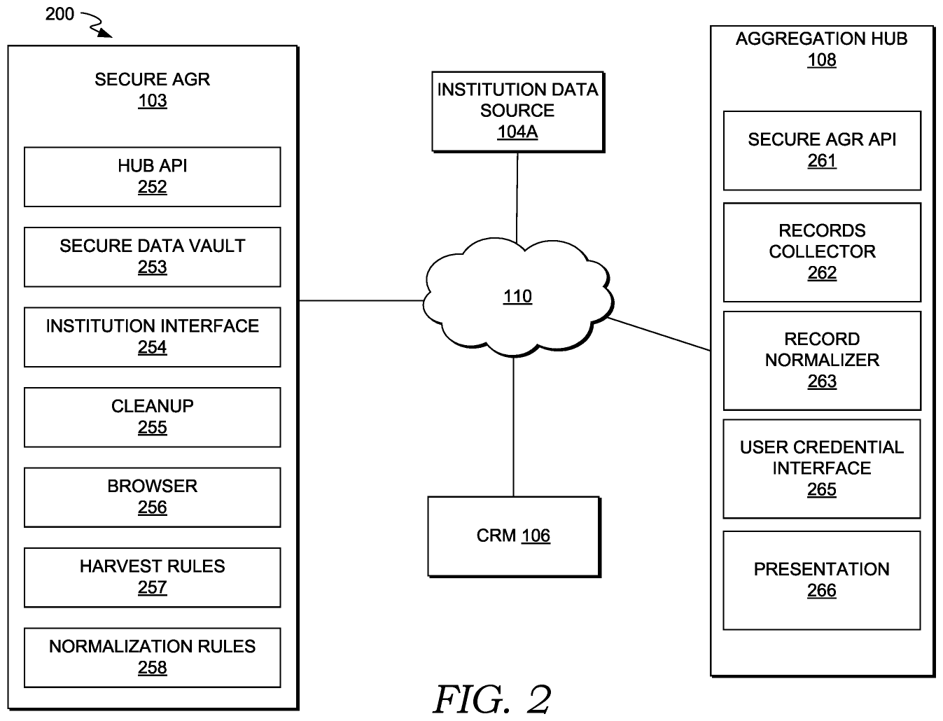

Data sources 104a and 104b through 104n may comprise institutional data sources and/or data systems, which are configured to make customer data available to any of the various constituents of operating environment 100 or system 200 described in connection to FIG. 2. The institutions may be financial institutions, such as a brokerage, insurance company, and/or bank. Examples of data source(s) 104a through 104n may be one or more of a database, a file, data structure, corpus, or other data store. Data sources 104a and 104b through 104n may be discrete from user devices 102a and 102b through 102n and CRM server 106. The data sources 104a and 104b through 104n may store account content, such balances, holdings, transactions, tax information, profits, losses, and financial plans. The data sources 104a and 104b through 104n may store customer profile information, including records of email, text, phone, or other communications from or to a customer.

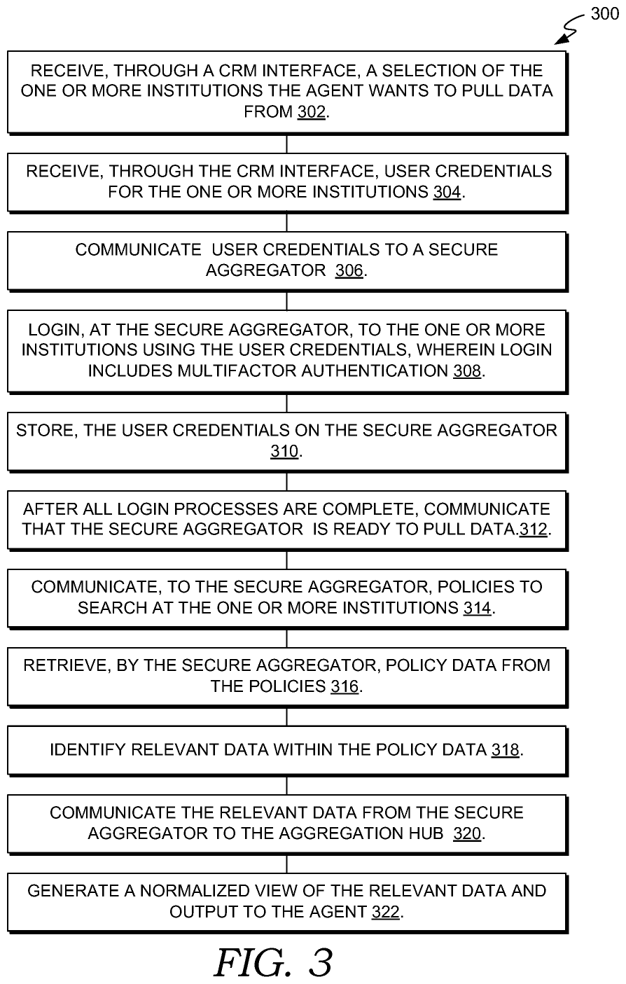

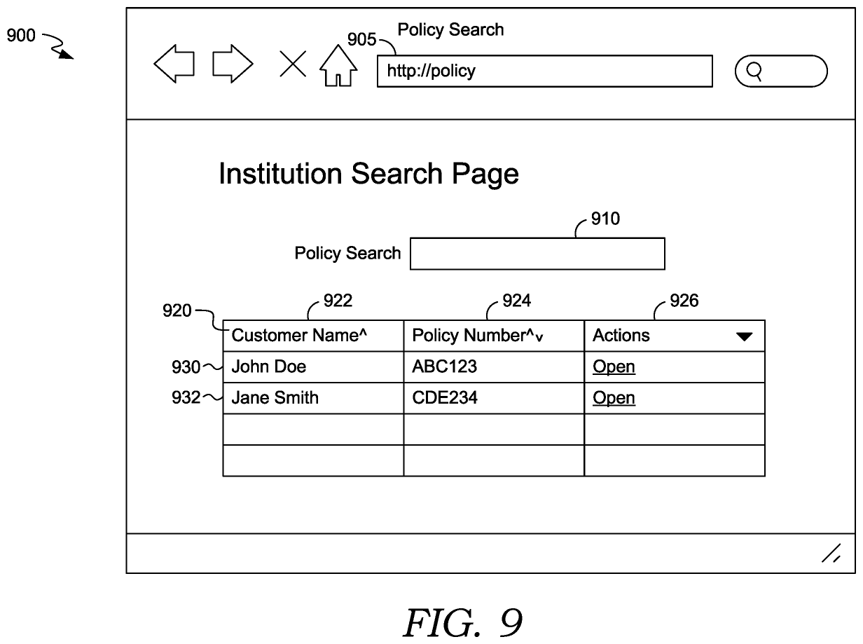

Operating environment 100 can be utilized to implement one or more of the components of the system 200, described in FIG. 2, including components for securely accessing and aggregating customer data, as described herein. Operating environment 100 also can be utilized for implementing aspects of process 300 described in conjunction with FIG. 3, and any other functionality as described in connection with FIGS. 2-12.

Referring now to FIG. 2, with FIG. 1, a block diagram is provided showing aspects of an example computing system architecture suitable for implementing some embodiments of the disclosure and designated generally as system 200. The system 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200 including secure aggregator 103, institutional data source 104a, CRM server 106, and aggregation hub 108. These components may be embodied as a set of compiled computer instructions or functions, program modules, computer software services, or an arrangement of processes carried out on one or more computer systems, such as computing device 1300 described in connection to FIG. 13, for example.

In one embodiment, the functions performed by components of system 200 are associated with one or more services or routines. In particular, such applications, services, or routines may operate on one or more user devices (such as user device 102a), servers (such as aggregation hub 108), may be distributed across one or more user devices and servers, or be implemented in the cloud. Moreover, these components, functions performed by these components, or services carried out by these components may be implemented at appropriate abstraction layer(s) such as the operating system layer, application layer, hardware layer of the computing system(s). Alternatively, or in addition, the functionality of these components and/or the embodiments described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs). Additionally, although functionality is described herein with regards to specific components shown in example system 200, it is contemplated that in some embodiments functionality of these components can be shared or distributed across other components.

Continuing with FIG. 2, example system 200 includes a secure aggregator 103, which may be a device similar to the secure aggregation devices 103a and 103b through 103n, described previously. The secure aggregator 103 includes an aggregation hub API 252, secure data vault 253, institution interface 254, cleanup component 255, browser 256, harvest rules 257, and normalization rules 258. The secure aggregator 103 may run a single “boss” service that starts when the device is booted. It will call the secure aggregator API to receive commands that control the overall operation of the device (like commands to update software, reboot the device, log into an institution, download customer data, or the like.)

The aggregation hub API 252 interacts with the secure aggregator API 261 to exchange information and commands.

The secure data vault 253 stores information retrieved from an institution. This information can include customer data retrieved for customers served by an agent. The institution may give an agent access to a customer's data based on a link between the customer account and the agent. The information may be stored until it is uploaded to the aggregation hub 108. Once uploaded, the customer information may be deleted. The secure data vault 253 may store credential information for an agent or other user during the login process. The credential information may be deleted once the login process completes, power is terminated, or the session with the institution terminates, amount other deletion triggers.

The institution interface 254 may be a service initiated by the “boss” service in response to a command from the secure aggregator API 261. This service will make its own regular calls to the secure aggregator API 261, asking for commands specific to a single institution (like commands to open a browser, log into the institution, search for policies, or download files).

The institution interface 254 can provide navigation, login, harvesting, and persistence functions. Navigation consists of code that goes to the appropriate pages for an institution. The URLs necessary to complete a job to get institution data may be programmed into the secure aggregation device 103. As institutions change or more institutions are updated, the new navigation processes are updated on the device. For example, a request to pull information for insurance policy “ABC123” will only contain the policy number inside the request, as the secure aggregation device 103 will have the programming to know what sequence of pages to visit on the website to access the data for the product.

The login process communicates the username, password, and/or other authentication information to an institution's webpage or other data interface. The security credentials may be provided by an agent, for example, at the start of a workday. The login credential may be stored in non-persistent computer memory. Data in non-persistent memory is not written to disk when the device shuts down. Therefore, any time that the device shuts down, whether normally or abnormally, the data in non-persistent memory is lost. The data in non-persistent memory may not logged or checkpointed. The non-persistent memory may be RAM.

The persistence functions attempts to keep the secure aggregation device 103 logged into an institution for as long as possible, up to a threshold period, such as a day. The persistence functions may take various actions, such as navigation actions, to make the secure aggregation device 103 appear to be an active user through the institution's website. These actions may be taken even though no data retrieval job is presently underway with the institution.

Harvesting consists of code that pulls information from a page. When pulling information to return to the secure aggregator API 261, the secure aggregation device 103 will apply strategies that consist of pattern checks to get information. These strategies include:

TABLE 1

| Strategy | Input | Output |
|---|---|---|
| Label: Value | First Name: John | { “First Name” : “John” } |
| Header Above Value | First Name | { “First Name” : “John” } |
| | John | |
| Horizontal Table Key Value | [First Name] [John] | { “First Name” : “John” } |
| Vertical Table Key Value | [First Name] | { “First Name” : “John” } |
| | [John] | |
| Two HTML Elements in a Div | <div> | { “Name”: “John” } |
| | <b>Name</b> | |
| | <span>John</span> | |
| | </div> | |
| Values Separated by line break | Name<br/>John | { “Name”: “John” } |
| tag | | |
| PDF Links on Page | <a | { “file”: “file.pdf”, “name”: |
| | href=“file.pdf”>Report</a> | “Report” } |
| Full Files on Page | <a | { “contents”: “[binary |
| | href=“file.pdf”>Report</a> | content]”, “name”: |
| | | “file.pdf” } |

This approach reduces the amount of work necessary to extract data from an institution, as there is no custom programming per institution. While every institution's website is different, the data is often presented in the same forms that can be extracted without custom programming. All harvesting (also described as data extraction) strategies are applied on the appropriate pages, and all of the data is combined into a single payload that is returned to the secure aggregator API 261.

The cleanup component 255 may be a service that is initiated by the boss service through a command from the secure aggregator API 261. The cleanup component 255 may continually scan the secure aggregator device 103 for remnants of data left from other operations (like checking that all downloaded files are deleted).

The browser 256 is an Internet browser. The browser 256 is used to access an institutional website and retrieve information. In aspects, the secure aggregator device 103 retrieves information by posing as a user. The secure aggregator device 103 navigates the institution's website as a user would, finds relevant information, and downloads it to the secure data vault 253 for processing.

The harvest rules 257 are used to find and retrieve data from an institution. The harvest rules can specify URL for particular pages from which data is to be retrieved. For example, the harvest rules can specify a customer details page URL, account details page URL, and the like. The harvest rules 257 can also be followed to interact with the page. The interactions can include inputting data (e.g., customer name, account number) in a search box and selecting various tabs, buttons, and/or controls.

The normalization rules 258 take the raw harvested data and shape it to fit inside the secure aggregator API 261. The shaping can including changing the data format to fit a schema, such as field length. This can including truncating data or padding, as required. The shaping can include distinguishing between relevant data and non-relevant data. The harvesting might pull all information from a transaction table, while only some of the information is requested and enterable into the secure aggregator API 261. Custom programming per institution can be used to do the shaping, but much of the shaping can be done with intelligent rules on what the data should look like.

Continuing with FIG. 2, example system 200 includes a CRM sever 106. The CRM server 106 can provide an interface through which an agent interacts with the aggregation hub 108. The CRM server 106 can provide customer data retrieved through the aggregation hub 108. The CRM server 106 can also provide an interface through which authentication information is provided by the agent in order to log into an institution. The authentication information can include multi-factor authentication fields that receive a code from the agent. The code may be texted or emailed to the agent by the institution as part of the login process. The authentication information is then passed to the aggregation hub 108, which in turn passes the information to the secure aggregation device 103.

The CRM server 106 may maintain customer records on behalf of an agent. The customer records include the names of institutions associated with each customer. For each institution associated with the customer, the unique customer identification may be used to identify the customer to the institution. The unique customer identification may be used to retrieve information for a specific customer. Unique customer identification may be passed to the aggregation hub 108 in order to create a job for the secure aggregation device 103 to perform. The job may include providing the unique customer identifications. The CRM server 106 may provide an interface through which agents can look up customer information, including financial information provided by the secure aggregation device 103.

Continuing with FIG. 2, example system 200 includes an aggregation hub 108. The aggregation hub 108 includes a secure aggregator API 261, records collector 262, record normalizer 263, user credential interface 265, and presentation component 266.

The secure aggregator API 261 interacts with the aggregation hub API 252. The secure aggregator API 261 may include endpoints shown below in table 2.

TABLE 2

| Endpoint | Input | Output |
|---|---|---|
| Boss | Unique ID | A single command to perform an operation related |
| | | to the overall operations of the secure aggregation |
| | | device. |
| Boss Command | Unique ID | The secure aggregation device will send the results |
| Result | Boss Command ID | of the boss commands to this endpoint. |
| | Result | |
| Institution | Unique ID | A single command to perform an operation related |
| | Agent Institution ID | to the secure aggregation device's interactions |
| | | with an institution. |
| Institution | Unique ID | The secure aggregation device will send the results |
| Command | Agent Institution ID | of the institution commands to this endpoint. |
| Result | Policy Number | |
| | Result | |

The secure aggregator API 261 may be used in the following way. The secure aggregator device 103 asks the secure aggregator API 261 for a job to do. If there are no jobs to do, secure aggregator device 103 will continue to ask the API for jobs to do. When there are jobs to do, the secure aggregator API 261 will provide only one job to secure aggregator device 103 at a time. The secure aggregator API 261 will mark that job as “processing.” The secure aggregator device 103 will complete the job and report the results of the job through the secure aggregator API 261. The secure aggregator API 261 will mark the job as “done”. Secure aggregator device 103 asks the secure aggregator API 261 for the next job to do.

The records collector 262 receives job data through the secure aggregator API 261. The job data can be provided in response to a query. For example, the query could ask the secure aggregator device 103 to provide information about a particular customer an agent is planning to have a conversation with. The job data could include customer data retrieved from multiple institutions at which the customer has accounts. The records collector 262 stores the data.

The record normalizer 263 fits the stored data into a standard format. The record normalizer 263 may perform the normalization prior to storing the data collected by the records collector 262. In another aspect, the record normalizer 263 normalizes the data for the purpose of presentation to an agent.

The user credential interface 265 requests agent credentials from an agent. The request may be sent through the CRM server 106. The credentials can be provided to the CRM server 106, which in turn provides them to the user credential interface 265. The credentials can include a user name and password for each institution the agent wants to retrieve information from. The user credentials are then passed to the secure aggregation device 103, which uses them to log into the institution.

The user credential interface 265 may assist with multi-factor authentication. In an aspect, the institution receiving a login request will email or text a code to the agent. The agent enters the code into the interface provided by the CRM server 106. The interface can specify the institution associated with the multi-factor authentication request to help the agent differentiate between multiple codes received from multiple institutions being logged into. The CRM server 106 passes the authentication information to the secure aggregation device 103, which uses them to log into the institution.

The presentation component 266 presents data retrieved by the secure aggregation device to the agent, possibly through the CRM server 106. The presentation component may present customer information in a common format regardless of the institution the data originated from. The presented information can include information about a customer retrieved from multiple institutions.

Now referring to FIG. 3, each block of methods 300, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by a standalone application, a service or hosted service (standalone or in combination with another hosted service), to name a few. In addition, method 300 are described, by way of example, with respect to additional features of FIGS. 1-2 and 4-13. However, these methods may additionally or alternatively be executed by any one system, or any combination of systems, including, but not limited to, those described herein.

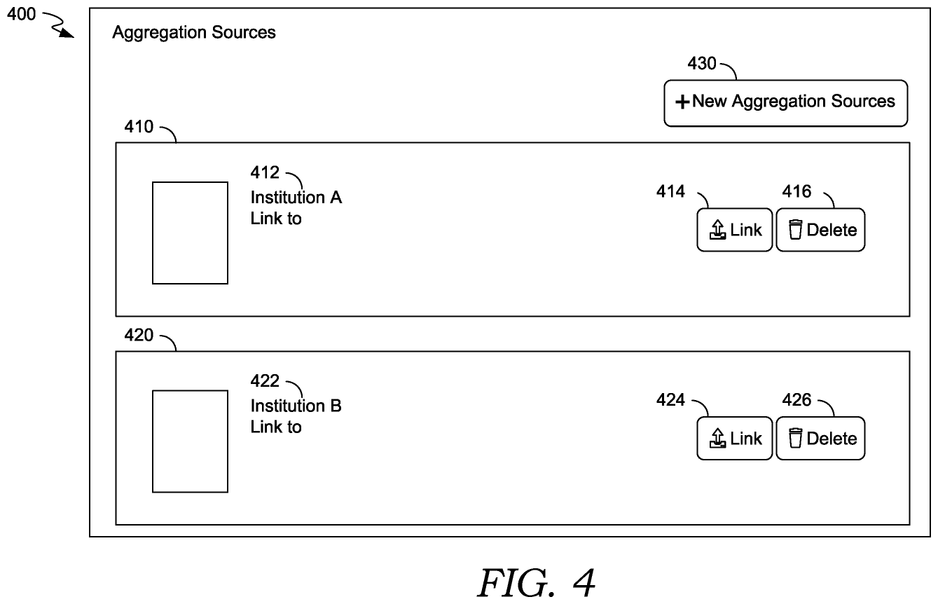

At step 302, method 300 includes receiving through a CRM interface a selection of one or more institutions the agent wants to pull data from. An example source-selection interface 400 is shown in FIG. 4. The source-selection interface 400 shows institution A 410 and institution B 420. Linking information for both of these institutions may have been provided previously. Once an institution is added to the system, linking to the institution may be initiated by selecting the link control. In this example, initiation of linking to institution A may be initiated by selecting the first link control 414. Initiation of linking to institution B may be initiated by selecting the second link control 424. Selecting an institution can initiate a data retrieval task where all customer data associated with the institution may be retrieved. All customer data would include only customer data for which the agent's credentials provide account access. As an alternative to selecting an institution, a selection of one or more customers (not shown) may be provided. Either selection acts as a starting point for building a data retrieval task.

If linking to an institution is no longer desired, the institutional linking information may be deleted from the CRM server (and/or other system components) by selecting the delete control. In this example, deletion of institution A information may be initiated by selecting the first delete control 416. Deletion of institution B information may be initiated by selecting the second delete control 426. The new aggregation source control 430 allows additional institutions to be identified and linked. Selecting the new aggregation source control 430 may open an interface through which linking to new institutions may be initiated. The login credential may be stored in non-persistent computer memory. Data in non-persistent memory is e not written to disk when the device shuts down. Therefore, any time that the device shuts down, whether normally or abnormally, the data in non-persistent memory is lost. The data in non-persistent memory may not logged or checkpointed

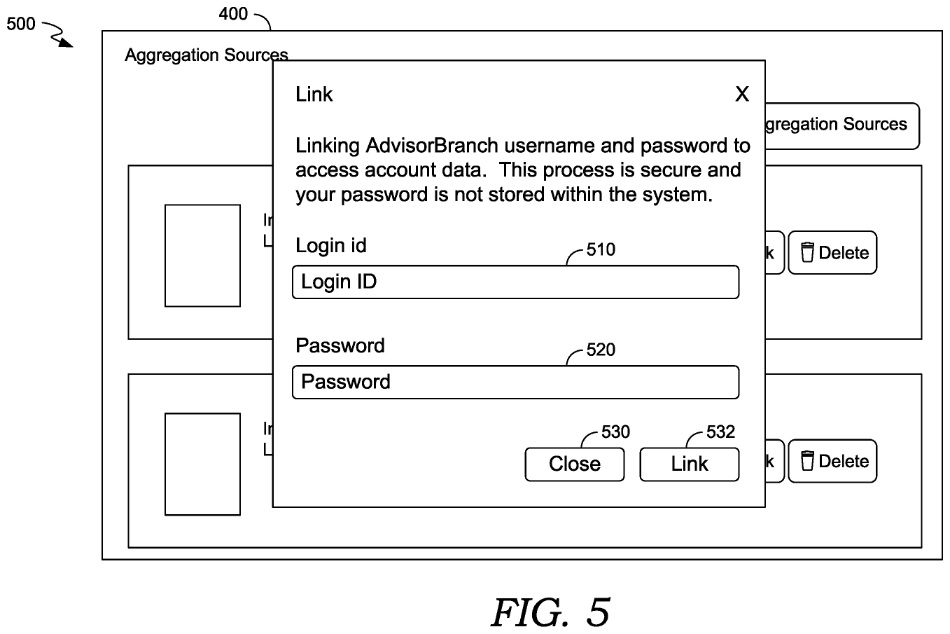

The selection may be communicated to an aggregation hub 108. The aggregation hub 108 then communicates a request to a secure aggregation device 103 associated with the agent making the selection. In aspects, each agent is associated with a single secure aggregation device. The secure aggregation device may navigate to a URL associated with the selected institution and initiated a login process. In aspects, the secure aggregation device 103 asks the aggregation hub 108 for user credentials. The aggregation hub 108 forwards the request to the CRM interface. Alternatively, the CRM interface automatically asks for agent credentials for an institution upon receiving a selection of an institution. The agent credentials may be requested through a credential interface, such as credential interface 500 shown in FIG. 5.

At step 304, method 300 includes receiving, through the CRM interface, agent credentials for the one or more institutions 304. The agent may be asked to supply the credentials with each log in through a credential interface 500, shown in FIG. 5. The credential interface 500 includes a first text box 510 for a login ID and a second text box 520 for a password. Once the login ID and password are entered, the login process may be initiated when the user selects the link 532 button. The login ID and password requirement maintains the same level of security as provided by the current institutional login process. The user may close the credential interface without logging in by selecting the close button 530.

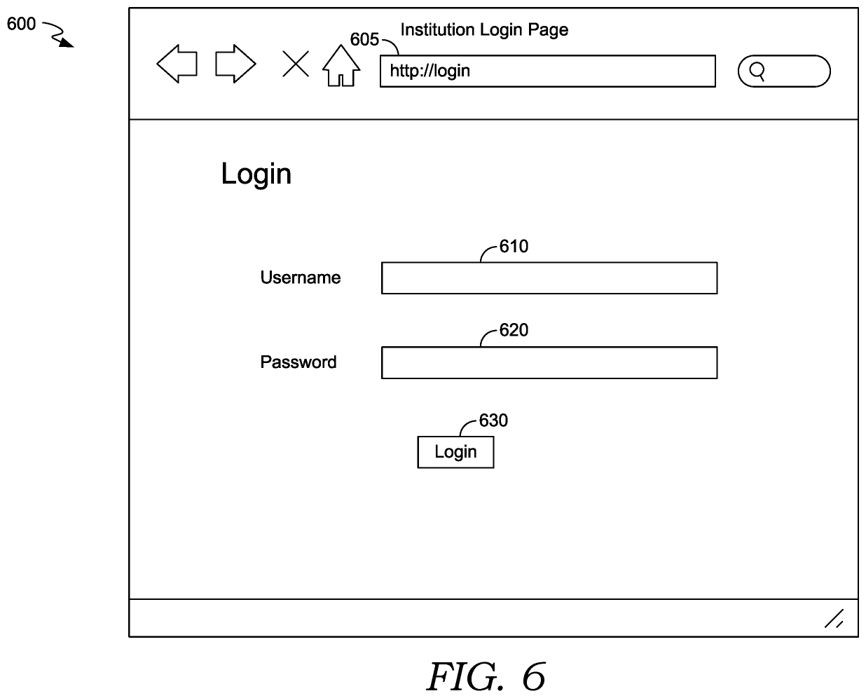

At step 306, method 300 includes communicating agent credentials to the secure aggregation device 103 via the aggregation hub 108. At step 308, method 300 includes the secure aggregation device 103 logging into the institution website using the agent credentials. An example institutional login interface 600 is shown in FIG. 6. The institutional login interface 600 may be accessed through the institution's login interface 600 accessible through a first URL 605. The institutional login interface 600 may be the same interface used by users or agents when directly accessing the institution data. In other words, the institutional login interface 600 may not require any modification for use with the aggregation device 103. Instead, the aggregation device 103 enters the previously supplied username in username box 610 and the previously supplied password in password box 620, and then activates the login control 630. The login process may include multifactor authentication. If so, the user may supply a received authentication code through the CRM interface (not shown). The authentication code may then be communicated to the secure aggregation device 103 and provided to the institution's login process. Other multi-factor authentication methods may be supported directly by the secure aggregation device 103. For example, the secure aggregation device 103 could be coupled to a fingerprint scanner, iris scanner, camera suitable for facial recognition, card reader, or some other sensor.

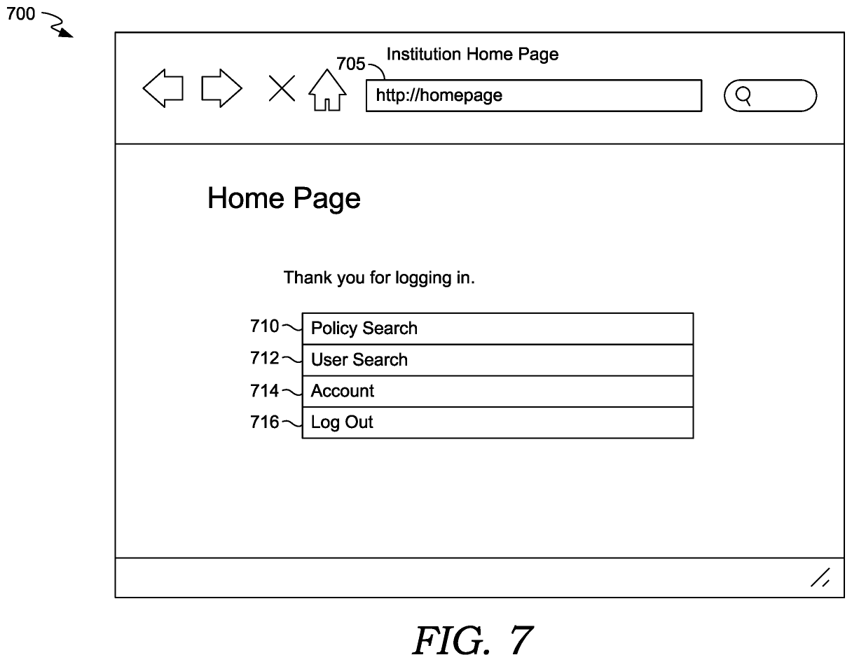

At step 310, method 300 includes storing the credentials on the secure aggregation device 103 in case the login process needs to be repeated during an agent session. At step 312, method 300 includes communicating that the secure aggregation device is logged into the institution's webpage. This message may be communicated to the aggregation hub 108 and/or CRM server 106. In response, a message may be communicated to the agent indicating that the aggregation session is now linked to the institution. An example successful linking message 710 is illustrated in linking interface 700 of FIG. 7. The successful linking message 710 may be dismissed by selecting the done button 712.

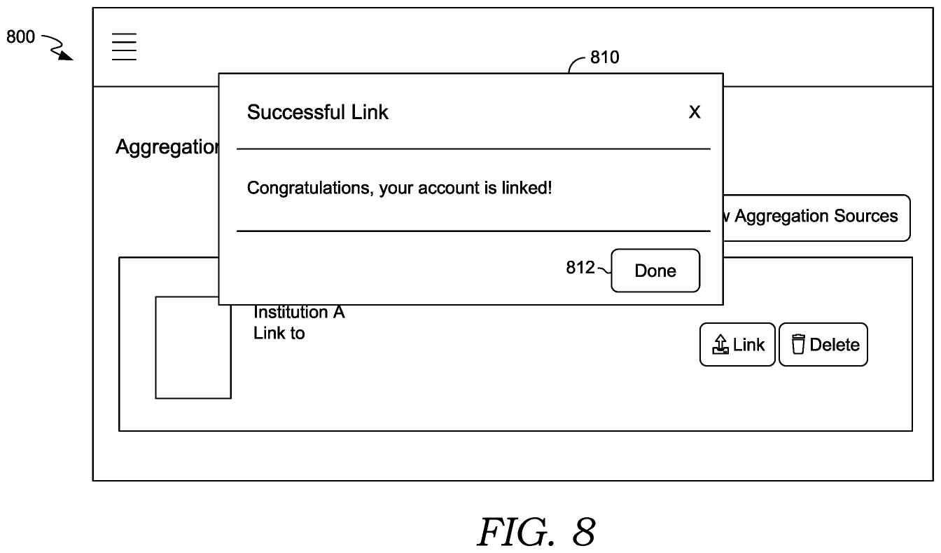

At step 314, method 300 includes communicating policies to search to the secure aggregation device 103. The goal of this request is to retrieve data for customer policies managed by the requesting agent. At step 316, method 300 includes retrieving, by the secure aggregation device 103, customer data responsive to the search request. Retrieving the customer data can include navigating the institution websites to find customer data to download. Initially, the browser on the secure aggregation device 103 may be taken to an institution's homepage, such as homepage 800 shown in FIG. 8. As with the login page, the homepage 800 may be built for agents to navigate and can include information for the agent's customers having accounts at the institution. The secure aggregation device 103 navigates the homepage 800 and other pages to locate and retrieve relevant data.

The homepage 800 may be accessed through the homepage URL 805. The secure aggregation device 103 may be automatically redirected to the homepage 800 upon completing the login process. Alternatively, the secure aggregation device 103 may navigate to the homepage 800 using the homepage URL 805. The homepage 800 includes a policy search link 810, a user search link 812, and account link 814, and a logout control 816. Selecting the policy search link 810 opens a policy search interface through which individual policies may be searched by, for example, using a policy number or policy holder's name, user ID, or the like. Selecting the user search link 812 may be bring up a user search page to find information about individual users. The agent's account information may be accessed by selecting the account link 814.

Upon selecting the policy search link 810, the policy search interface 900 may be accessed. The policy search interface 900 may be accessed through the policy search URL 905. The policy search interface 900 includes a policy search box 910 into which policy information (e.g., customer name and/or policy number) may be entered to retrieve a specific policy. The policy table 920 shows a list of policies that the agent associated with the login credentials is managing. The first column 922 displays the customer name, the second column 924 displays the policy number, and third column 926 includes a link that will open a policy detail page, if selected. The table shows two policies for the sake of simplicity. In reality, the policy table 920 could include a large number of policies that may be navigated by scrolling. The first row 930 displays a policy for John Doe. The second row 932 displays a policy for Jane Smith.

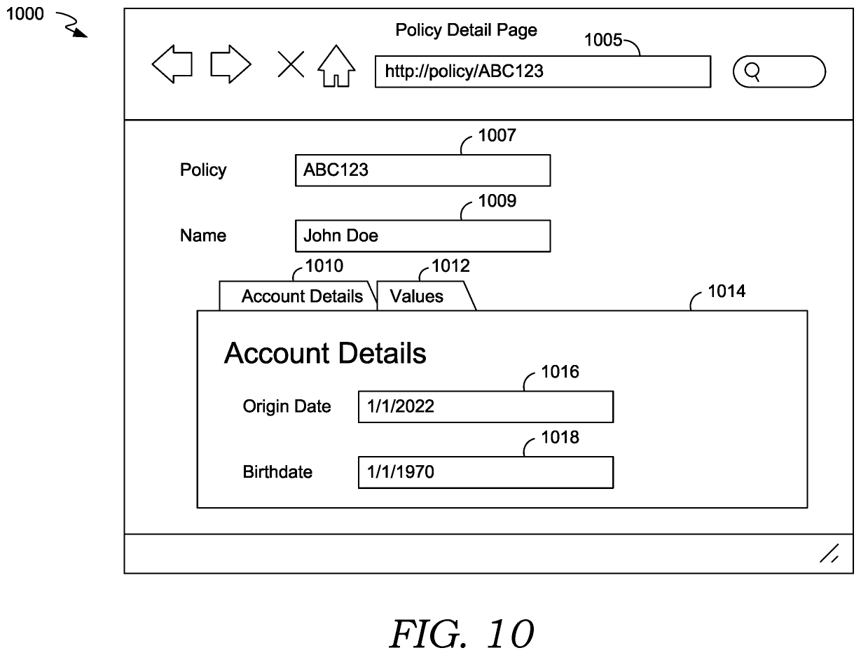

Upon selecting the action link in the third column 926 and the first row 930, a policy details page could be accessed. An example policy details page 1000 is shown in FIG. 10. The policy details page 1000 may be accessed through policy detail URL 1005. The policy detail page 1000 includes the policy identifier 1007 and the name 1009 associated with the policy. The policy details page 1000 includes an account details tab 1010 and a values tab 1012. In this example, the account details tab 1010 is active causing the account details view 1014 to be displayed. The account details view 1014 includes an origin date 1016 for the account and the account holder's birthdate 1018. This is just an example and account details views could include other information.

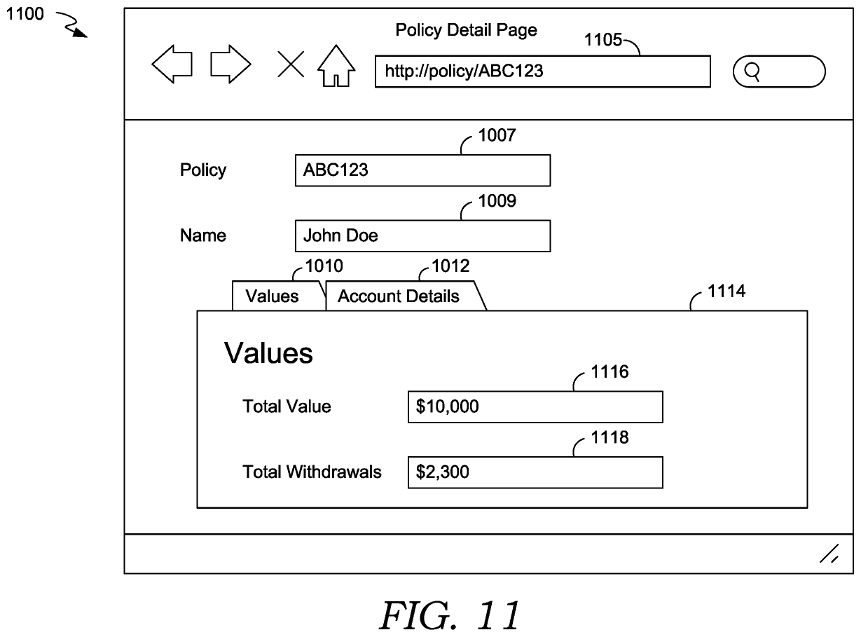

In FIG. 11, the values tab 1012 has been selected which causes a values view 1114 to be displayed. The values view 1114 includes a total account value 1116 and total account withdrawals 1118. This is just an example and value details views could include other information.

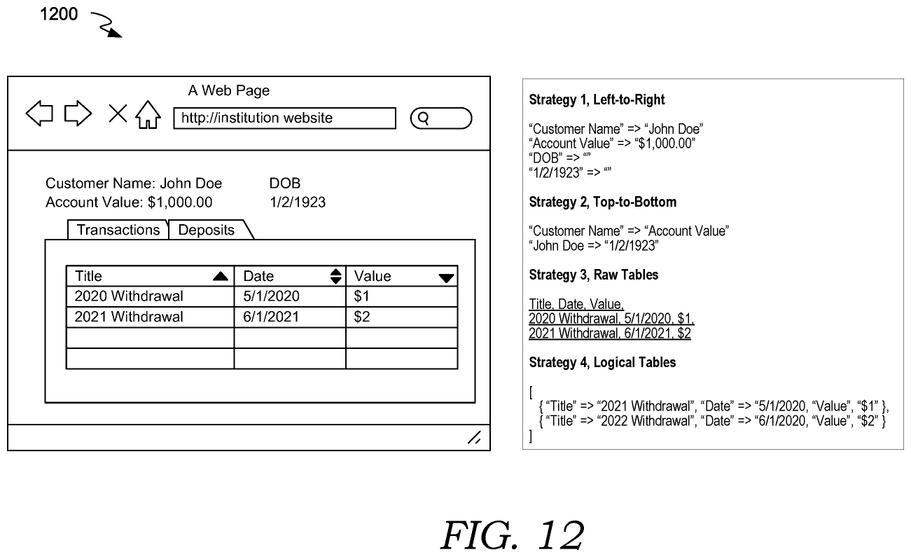

Customer data may be retrieved in multiple formats and using multiple strategies, which can produce a redundant collection of data. Four different search strategies are illustrated in FIG. 12, which shows a customer detail page 1200. The customer detail page 1200 may be accessed at customer detail URL 1205. The customer detail page 1200 displays the customer name 1207, the customer date of birth 1208, and the account value 1209. The customer detail page 1200 includes a transactions tab 1211 and a deposits tab 1213. In this example, the transactions tab 1211 is active causing a transactions view 1214 to be displayed. The transactions view 1214 includes a transaction table 1220 showing two transactions. The first column 1225 of the transaction table 1120 shows the title of the transaction. The second column 1227 shows the date of the transaction and the third column 1229 shows the amount of the transaction.

In aspects, the secure aggregation device 103 uses search strategies to retrieve information from the customer detail interface 1200. The search strategies are designed to work with multiple institutions and with various layout changes. In other words, the combination of search strategies and corresponding analysis of the results should retrieve information that can be understood by the secure aggregation device 103 and translated into a common interface format for display to the agent.

The first strategy example 1220 illustrates a left-to-right to right data extraction strategy. Left-to-right data extraction is a technique for extracting data from a source (e.g., web page or a table) in a horizontal manner. It involves scanning the web page or table from left to right, row by row, and extracting the data values from each cell or element. The web page can be viewed as a table, where each row represents an attribute and each column in the row represents a corresponding value. In aspects, gaps (e.g., white space) in web page content may be interpreted as starting a new table. The extracted data can be stored in a structured format, such as a CSV file, a JSON file, or a database table.

One example of left-to-right data extraction is provided in the left-to-right data example 1220. The web page can be viewed as a table, where each row of text or table row represents an attribute and each column represents a value. The data extraction process can start from the top left corner of the page content and move to the right, extracting the name of the attribute from the first “column”. Then, it can move to the next column and extract the value of the corresponding attribute. This process can be repeated for all the columns in the first row. Then, the process can move to the second row and extract the data for the second element, and so on, until all the rows are processed. The extracted data can be stored in a CSV file, where each row corresponds to an element and each column corresponds to an attribute associated with the element.

Using the data in the customer detail interface 1200, the left-to-right data extraction strategy 1220 results in the “customer name” attribute being correctly associated with the John Doe value in a first data record. This strategy also results in the “account value” attribute being correctly associated with a “$1 million” value in a second data record. In this example, the white space between customer name and DOB was interpreted as the DOB starting a new table. The DOB attribute is not associated with data and the date of birth value of 1/2/1923, is identified as an attribute rather than the DOB value. If the white space was not interpreted as a table separator then the DOB would be a value for customer name and the 1/2/1923 would be a value of account value. These would both also be wrong.

The second data extraction strategy is illustrated with top-to-bottom example 1230. Top-to-bottom data extraction is a technique for extracting data from a web page or a table in a sequential manner. It involves scanning the web page or table from top to bottom, element by element, and extracting the data values from each cell or element. The extracted data can be stored in a structured format, such as a CSV file, a JSON file, or a database table.

One example of left-to-right data extraction is provided in the top-to-bottom data extraction example 1230. The web page can be viewed as a list, where each attribute represents a column heading with values associated with the heading found below the heading. The data extraction process can start from the top of the list and move to the bottom, extracting the column heading text and the associated values. The extracted data can be stored in a JSON file, where each element corresponds to an object with two properties: headline and link.

The top-to-bottom data extraction example 1230 correctly identifies the customer name attribute, but incorrectly associated it with the account value attribute. Similarly, the John Doe value is incorrectly identified as an attribute and incorrectly associated with the million dollar value. However, the DOB attribute is associated with the correct birth date value.

A third strategy is illustrated in a raw table strategy example 1240. The raw table strategy applies to tables and captures all data, including column headers and row headers as comma delimited rows. All data in a row is entered into a data field using a delimiter, such as a comma. Raw table strategy is a technique for extracting information from a table without any preprocessing or parsing. It involves reading the table as a raw text file and extracting the information by using regular expressions, string manipulation, or other text processing methods. The extracted information can be stored in a structured format, such as a CSV file, a JSON file, or a database table.

One example of raw table strategy data extraction is provided in the raw table strategy example 1240. The page can be viewed as a raw text file, where each row represents an attribute and each column in the row represents a value for the attribute. The information extraction process can start from the first row and read the text until it encounters a newline character. Then, it can split the text by using a delimiter, such as a comma, a tab, or a space. This process can be repeated for all the rows in the table. The extracted information can be stored in a JSON file, where each element corresponds to an object with two properties: name and population.

Using the raw table strategy example 1240 results in a first data set include the column headers “title, date, and value.” The second data set includes “2020 withdrawal, 5/1/2020, and $1.” The third data set includes “2021 withdrawal, 6/1/2020, and $2.”

A forth strategy is illustrated in a logical table strategy example 1240. The logical table strategy attempts to associate a column header and/or row header with corresponding data in the table. Logical table strategy is a technique for extracting information from a table by using its logical structure and semantics. It involves identifying the table elements, such as headers, rows, columns, cells, or subtables, and extracting the information by using their relationships, labels, or values. The extracted information can be stored in a structured format, such as a CSV file, a JSON file, or a database table.

The information extraction process can start from the first row and read the header text to identify the title, date, and value. Then, it can read the cell value to extract the title, date and value of each transaction. Thus, the title attribute from the first column would be associated with the “2020 withdrawl” value and the “2021 withdrawl” value. Similarly, the date header can be used to form two attribute value pairs and the value header can be used to form two additional attribute value pairs. This process can be repeated for all the cells in the table. The extracted information can be stored in a CSV file, where each row corresponds to a country and each column corresponds to a medal type.

Customer data that is not directly responsive to the search query may be collected. Accordingly, at step 318, method 300 includes identifying relevant data within the retrieve data. The relevant data is the data that is responsive to the search request. At step 320, method 300 includes communicating the relevant data to the aggregation hub. At step 322, method 300 includes communicating a normalized view of the relevant data to the agent.

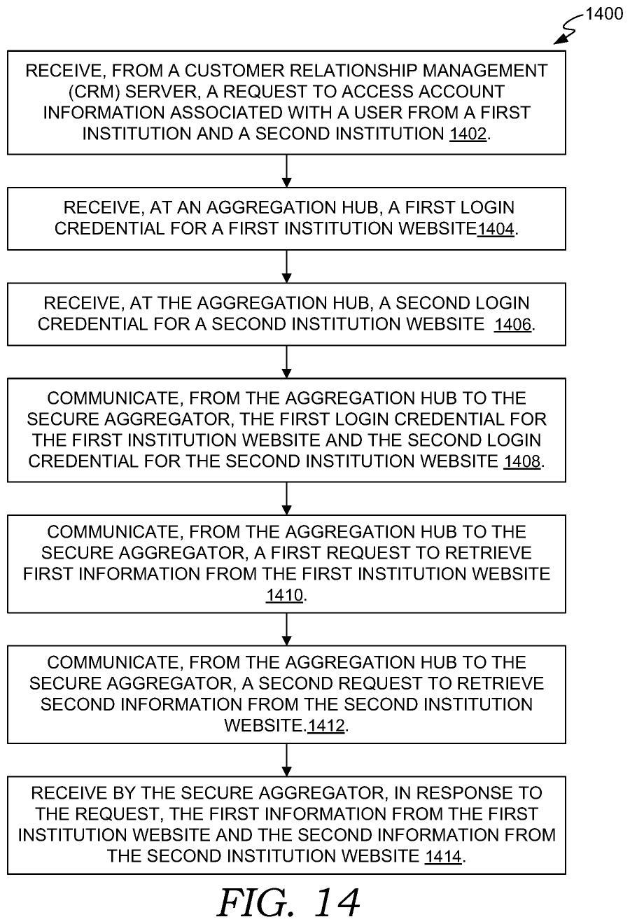

Turning now to FIG. 14, a method 1400 of providing secure access to website content is described according to an embodiment of the technology described herein. Method 1400 may be performed in a computing system described previously, for example with reference to FIGS. 1-13.

At step 1402, the method 1400 includes receiving, at a secure aggregator and from an aggregation hub, a login request for an institution website. At step 1404, the method 1400 includes receiving, at the secure aggregator from the aggregation hub, a login credential for the institution website. At step 1406, the method 1400 includes storing the login credential in non-persistent memory.

At step 1408, the method 1400 includes providing, by the secure aggregator, the login credential to the institution website. At step 14010, the method 1400 includes receiving, by the secure aggregator, a login confirmation from the institution website. At step 1412, the method 1400 includes communicating, by the secure aggregator, an indication that the secure aggregator is logged into the institution website to the aggregation hub. At step 1414, the method 1400 includes performing, by the secure aggregator, an action to keep the secure aggregator logged into the institution website.

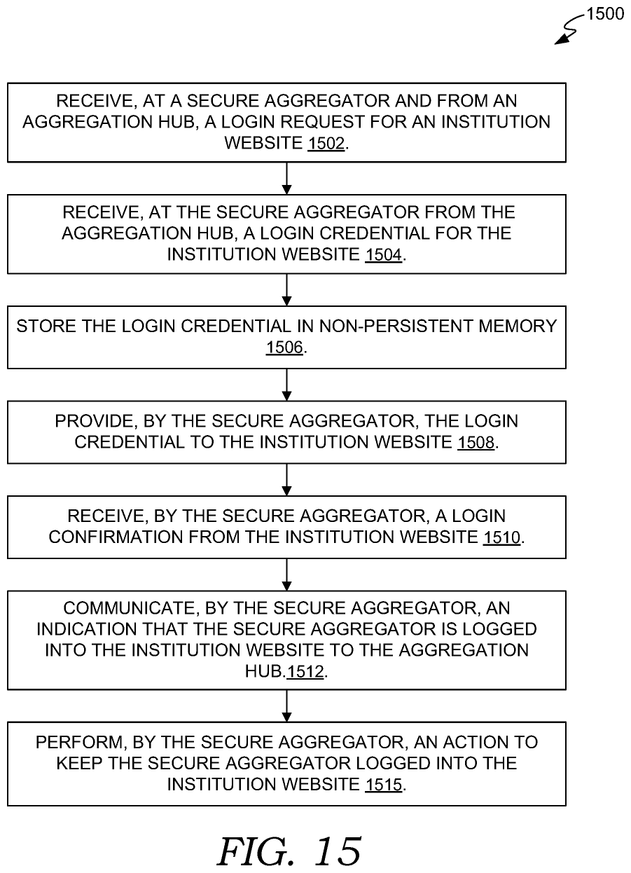

Turning now to FIG. 15, a method 1500 of providing secure access to website content is described according to an embodiment of the technology described herein. Method 1400 may be performed in a computing system described previously, for example with reference to FIGS. 1-13.

At step 1502, the method 1500 includes receiving, at a secure aggregator and from an aggregation hub, a login request for an institution website. At step 1504, the method 1500 includes receiving, at the secure aggregator from the aggregation hub, a login credential for the institution website. At step 1506, the method 1500 includes storing the login credential in non-persistent memory. At step 1508, the method 1500 includes providing, by the secure aggregator, the login credential to the institution website.

At step 15010, the method 1500 includes receiving, by the secure aggregator, a login confirmation from the institution website. At step 1512, the method 1500 includes communicating, by the secure aggregator, an indication that the secure aggregator is logged into the institution website to the aggregation hub. At step 1515, the method 1500 includes performing, by the secure aggregator, an action to keep the secure aggregator logged into the institution website.

### Overview of Example Operating Environment

Having described various embodiments of the disclosure, an exemplary computing environment suitable for implementing embodiments of the disclosure is now described. With reference to FIG. 13, an exemplary computing device 1300 is provided and referred to generally as computing device 1300. The computing device 1300 is but one example of a suitable computing environment and is not intended to suggest any limitation as to the scope of use or functionality of the disclosure. Neither should the computing device 1300 be interpreted as having any dependency or requirement relating to any one or combination of components illustrated.

Embodiments of the disclosure may be described in the general context of computer code or machine-useable instructions, including computer-useable or computer-executable instructions, such as program modules, being executed by a computer or other machine, such as a smartphone, a tablet PC, or other mobile device, server, or client device. Generally, program modules, including routines, programs, objects, components, data structures, and the like, refer to code that performs particular tasks or implements particular abstract data types. Embodiments of the disclosure may be practiced in a variety of system configurations, including mobile devices, consumer electronics, general-purpose computers, more specialty computing devices, or the like. Embodiments of the disclosure may also be practiced in distributed computing environments where tasks are performed by remote-processing devices that are linked through a communications network. In a distributed computing environment, program modules may be located in both local and remote computer storage media including memory storage devices.

Some embodiments may comprise an end-to-end software-based system that can operate within system components described herein to operate computer hardware to provide system functionality. At a low level, hardware processors may execute instructions selected from a machine language (also referred to as machine code or native) instruction set for a given processor. The processor recognizes the native instructions and performs corresponding low-level functions relating, for example, to logic, control and memory operations. Low-level software written in machine code can provide more complex functionality to higher levels of software. Accordingly, in some embodiments, computer-executable instructions may include any software, including low-level software written in machine code, higher-level software such as application software and any combination thereof. In this regard, the system components can manage resources and provide services for system functionality. Any other variations and combinations thereof are contemplated with embodiments of the present disclosure.

With reference to FIG. 13, computing device 1300 includes a bus 1310 that directly or indirectly couples the following devices: memory 1312, one or more processors 1314, one or more presentation components 1316, one or more input/output (I/O) ports 1318, one or more I/O components 1320, and an illustrative power supply 1322. Bus 1310 represents what may be one or more busses (such as an address bus, data bus, or combination thereof). Although the various blocks of FIG. 13 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 13 is merely illustrative of an exemplary computing device that can be used in connection with one or more embodiments of the present disclosure. Distinction is not made between such categories as “workstation,” “server,” “laptop,” “handheld device,” or other computing device, as all are contemplated within the scope of FIG. 13 and with reference to “computing device.”

Computing device 1300 typically includes a variety of computer-readable media. Computer-readable media can be any available media that can be accessed by computing device 1300 and includes both volatile and nonvolatile media, removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 1300. Computer storage media does not comprise signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 1312 includes computer storage media in the form of volatile and/or nonvolatile memory. The memory may be removable, non-removable, or a combination thereof. Exemplary hardware devices include solid-state memory, hard drives, optical-disc drives, or other hardware. Computing device 1300 includes one or more processors 14 that read data from various entities such as memory 1312 or I/O components 1320. Presentation component(s) 1316 presents data indications to a user or other device. Exemplary presentation components include a display device, speaker, printing component, vibrating component, and the like.

The I/O ports 1318 allow computing device 1300 to be logically coupled to other devices, including I/O components 1320, some of which may be built in. Illustrative components include a microphone, joystick, game pad, satellite dish, scanner, printer, wireless device, and the like. The I/O components 1320 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1300. The computing device 1300 may be equipped with depth cameras, such as stereoscopic camera systems, infrared camera systems, RGB camera systems, and combinations of these, for gesture detection and recognition. Additionally, the computing device 1300 may be equipped with accelerometers or gyroscopes that enable detection of motion. The output of the accelerometers or gyroscopes may be provided to the display of the computing device 1300 to render immersive augmented reality or virtual reality.

Some embodiments of computing device 1300 may include one or more radio(s) 1324 (or similar wireless communication components). The radio 1324 transmits and receives radio or wireless communications. The computing device 1300 may be a wireless terminal adapted to receive communications and media over various wireless networks. Computing device 1300 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (e.g., a primary connection and a secondary connection). A short-range connection may include, by way of example and not limitation, a Wi-Fi® connection to a device (for example, mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Having identified various components utilized herein, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions, and the like.) can be used in addition to or instead of those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

The term “set” may be employed to refer to an ordered (e.g., sequential) or an unordered (e.g., non-sequential) collection of objects (or elements), such as but not limited to data elements (for example, events, clusters of events, and the like). A set may include N elements, where N is any non-negative integer. That is, a set may include 0, 1, 2, 3, . . . N objects and/or elements, where N is an positive integer with no upper bound. Therefore, a set may be a null set (e.g., an empty set), that includes no elements. A set may include only a single element. In other embodiments, a set may include a number of elements that is significantly greater than one, two, or three elements. The term “subset,” is a set that is included in another set. A subset may be, but is not required to be, a proper or strict subset of the other set that the subset is included in. That is, if set B is a subset of set A, then in some embodiments, set B is a proper or strict subset of set A. In other embodiments, set B is a subset of set A, but not a proper or a strict subset of set A.

The invention claimed is:

1. A system comprising:
at least one computer processor; and
one or more computer storage media storing computer-useable instructions that, when used by the at least one computer processor, cause the at least one computer processor to perform operations comprising:
receiving, at a secure aggregator and from an aggregation hub, a login request for an institution website;
receiving, at the secure aggregator from the aggregation hub, a login credential for the institution website;
providing, by the secure aggregator, the login credential to the institution website;
receiving, by the secure aggregator, a login confirmation from the institution website; and
communicating, by the secure aggregator, an indication that the secure aggregator is logged into the institution website to the aggregation hub.

2. The system of claim 1, further comprising:
receiving, from the aggregation hub, a multi-factor authentication for the institution website; and
providing the multi-factor authentication to the institution website.

3. The system of claim 1, further comprising:
receiving, by the secure aggregator, a request to retrieve information from the institution website;
navigating the institution website to find the requested information;
extracting raw data from the institution website using one or more strategies;
identifying relevant data in the raw data; and
communicating the relevant data to the aggregation hub.

4. The system of claim 3, wherein the one or more strategies for non-table content in the website is selected from the group consisting of left-to-right extraction and top-to-bottom extraction.

5. The system of claim 1, further comprising receiving a deletion trigger and deleting credential information from the secure aggregator.

6. The system of claim 5, wherein the deletion trigger is a designated time of day.

7. The system of claim 1, wherein the login credential is stored in non-persistent computer memory.

8. A method of maintaining secure access to website content, the method comprising:
receiving, from a customer relationship management (CRM) server, a request to access account information associated with a user from a first institution and a second institution;
receiving, at an aggregation hub, a first login credential for a first institution website;
receiving, at the aggregation hub, a second login credential for a second institution website;
communicating, from the aggregation hub to the secure aggregator, the first login credential for the first institution website and the second login credential for the second institution website;
communicating, from the aggregation hub to the secure aggregator, a first request to retrieve first information from the first institution website;
communicating, from the aggregation hub to the secure aggregator, a second request to retrieve second information from the second institution website; and
receiving by the secure aggregator, in response to the request, the first information from the first institution website and the second information from the second institution website.

9. The method of claim 8, further comprising:
requesting, at the aggregation hub, the multi-factor authentication for the first institution website from the CRM server;
receiving, at the aggregation hub, a multi-factor authentication for the first institution website;
providing the multi-factor authentication to the secure aggregator.

10. The method of claim 8, further comprising normalizing the first information and the second information according to a schema applicable to data from multiple institutions to form normalized information.

11. The method of claim 8, further comprising output to the CRM server the normalized information.

12. The method of claim 8, further comprising receiving a request for a job from the secure aggregator and responding with an indication that a job is not available for processing.

13. A method of maintaining secure access to website content, the method comprising:
receiving, at a secure aggregator and from an aggregation hub, a login request for an institution website;
receiving, at the secure aggregator from the aggregation hub, a login credential for the institution website;
storing the login credential in non-persistent memory;
providing, by the secure aggregator, the login credential to the institution website;
receiving, by the secure aggregator, a login confirmation from the institution website;
communicating, by the secure aggregator, an indication that the secure aggregator is logged into the institution website to the aggregation hub; and
performing, by the secure aggregator, an action to keep the secure aggregator logged into the institution website.

14. The method of claim 13, further comprising:
communication, by the secure aggregator, a request for a job to perform to the aggregation hub.

15. The method of claim 13, further comprising:
receiving, by the secure aggregator, a request to retrieve information from the institution website;
navigating the institution website to find the requested information;
extracting raw data from the institution website using one or more strategies;
identifying relevant data in the raw data; and
communicating the relevant data to the aggregation hub.

16. The method of claim 15, wherein the one or more strategies for non-table content in the website is selected from the group consisting of left-to-right extraction and top-to-bottom extraction.

17. The method of claim 13, further comprising receiving a deletion trigger and deleting credential information from the secure aggregator.

18. The method of claim 17, wherein the deletion trigger is a designated time of day.

19. The method of claim 13, wherein the login credential is stored in non-persistent computer memory.
